(19) United States
(12) Patent Application Publication
(10) Pub. No.: US 2026/0141493 A1
(43) Pub. Date: May 21, 2026

(54) RADAR REFLECTIVITY PREDICTION FROM GEOSTATIONARY SATELLITE DATA VIA HYBRID DIFFUSION REGRESSION MODELS

(71) Applicant: NVIDIA Corporation, Santa Clara, CA (US)

(72) Inventors: Piyush Garg, Lisle, IL (US); Jaideep Satyajit Pathak, Oakland, CA (US); Noah Brenowitz, Seattle, WA (US); Yair Cohen, Hollywood, FL (US); Dale R. Durran, Seattle, WA (US); Karthik Kashinath, Issaquah, WA (US); Akshay Subramaniam, Campbell, CA (US); Suman Ravuri, London (GB); Mike Pritchard, Encinitas, CA (US)

(21) Appl. No.: 19/266,593

(22) Filed: Jul. 11, 2025

Related U.S. Application Data
(60) Provisional application No. 63/723,397, filed on Nov. 21, 2024.

(51) Int. Cl. G06T 5/70

(52) U.S. Cl. CPC G06T 5/70; G06T 2207/20182

(57) ABSTRACT

Apparatuses, systems, and techniques for meteorological prediction. In at least one embodiment, a neural network model includes at least one regression model and a diffusion model. The at least one regression model is configured to obtain first observation corresponding to a geographical region, and predict a first image representing a second observation corresponding to the geographical region. The diffusion model is configured to predict, based on the first image, a second image representing a refined second observation corresponding to the geographical region.

### CLAIM OF PRIORITY

This application claims the benefit of U.S. Provisional Application No. 63/723,397 titled “GOES2MRMS: Implementing Hybrid Diffusion-Regression Models To Predict Radar Reflectivity From Geostationary Satellites,” filed Nov. 21, 2024, the entire contents of which are incorporated herein by reference.

### BACKGROUND

Weather radar observations are crucial for timely severe weather warnings and aviation safety. However, radar coverage remains sparse globally, creating significant information gaps. Even in the United States, the western region has limited coverage, hampering effective weather forecasting. This sparsity is particularly acute over remote areas like open oceans—where hurricanes originate—and in developing countries with minimal radar infrastructure due to resource constraints. While previous studies have addressed radar coverage gaps, they've been limited to regional solutions without global applicability.

### BRIEF DESCRIPTION OF THE DRAWINGS

The present systems and methods for radar reflectivity prediction are described in detail below with reference to the attached drawing figures, wherein:

FIG. 1A shows example data from GOES-16 Level 1B radiance channels, in accordance with one or more embodiments.

FIG. 1B illustrates an example image representing Multi-Radar Multi-Sensor (MRMS) composite reflectivity (REFC) fields, in accordance with one or more embodiments.

FIG. 2A is a flowchart illustrating a method for training a neural network model, in accordance with one or more embodiments.

FIG. 2B is a flowchart illustrating a method 250 for meteorological prediction, in accordance with one or more embodiments.

FIG. 3A is a flow diagram illustrating a method for meteorological prediction, in accordance with one or more embodiments.

FIG. 3B illustrates results from meteorological prediction, in accordance with one or more embodiments.

FIG. 3C illustrates results from meteorological prediction, in accordance with one or more embodiments.

FIG. 3D shows training dataset used for both regression and diffusion models, in accordance with one or more embodiments.

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed herein that relate to predicting radar reflectivity from geostationary satellites, and in particular, to a machine learning based solution to transform widely available satellite data into high-resolution radar reflectivity predictions that address the problem of information gaps caused by sparse global radar coverage.

In one or more embodiments, a neural network model is trained and used to predict one type of observation data based on another. In the context of meteorological applications, certain types of observation data—such as radar reflectivity, which is heavily relied upon for estimating surface precipitation globally—may be abundant in some geographic regions but sparse in others. The neural network model can leverage a more widely available type of observation data, such as satellite data, to predict the desired type of observation data, such as radar reflectivity fields, in areas where it is otherwise limited.

In one or more embodiments, the neural network model obtains radiance observations from geostationary satellites (e.g., GOES data) to predict radar reflectivity fields, such as composite reflectivity (REFC) fields. This approach may help supplement data in regions where direct measurements from ground-based radars are unavailable. Geostationary satellites provide comprehensive radiance observations at high spatiotemporal resolution. For example, the neural network model can learn fundamental relationships between satellite-based signatures and radar reflectivity patterns, enabling the use of satellite observations to reconstruct REFC fields.

In one or more embodiments, the neural network model includes a regression model and a diffusion model. The regression model is trained to predict a second observation based on a first observation. The diffusion model is trained to refine the second observation predicted from the regression model.

In one or more embodiments, the first observation is represented in a first data space, which includes data from one or more first channels. Similarly, the second observation is represented in a second data space, which includes data from one or more second channels. The first and second channels may be the same or different. The number of first channels may be the same as or different from the number of second channels. In one or more embodiments, the first observation corresponds to GOES data, where first channels refer to specific wavelength ranges of electromagnetic radiation used to capture data from the Earth's atmosphere or surface. The first observation may include data from one or more first channels of GOES data. The second observation corresponds to REFC fields, which may be a single data layer (or channel) of composite reflectivity field. Various types of data, such as precipitation intensity, wind speed, or the atmospheric conditions, can be derived from the REFC fields. These derived data products, which are associated with different radar measurements, may be referred to as the “second channels.”

In one or more embodiments, GOES radiance dataset (corresponding to the first observation data) and Multi-Radar Multi-Sensor (MRMS) REFC dataset (corresponding to the second observation data) are used for training the model at various stages. In at least one embodiment, the GOES data and the MRMS REFC data are resampled onto the same pixel grid, such that the GOES training data and the MRMS REFC training data are on the common grid both spatially and temporally.

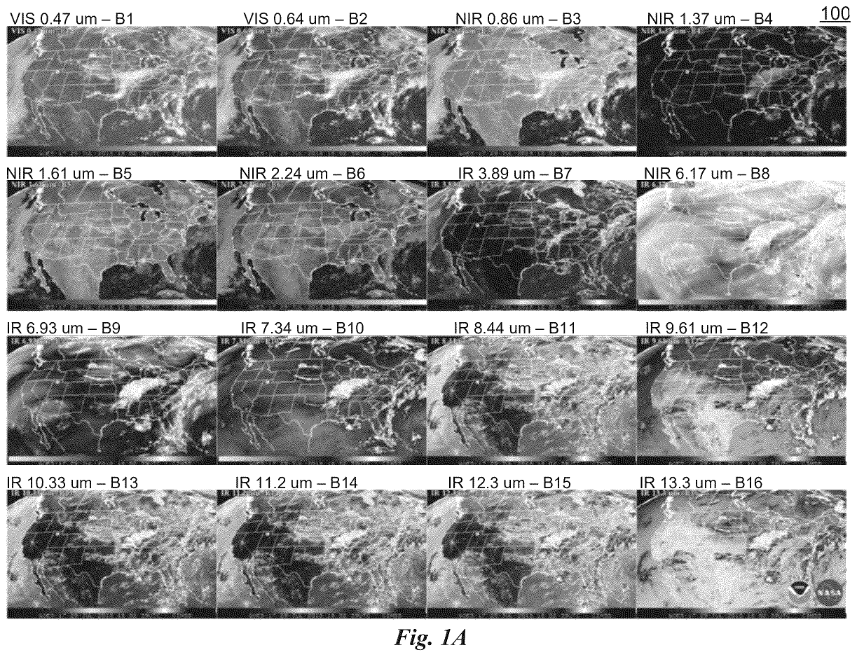

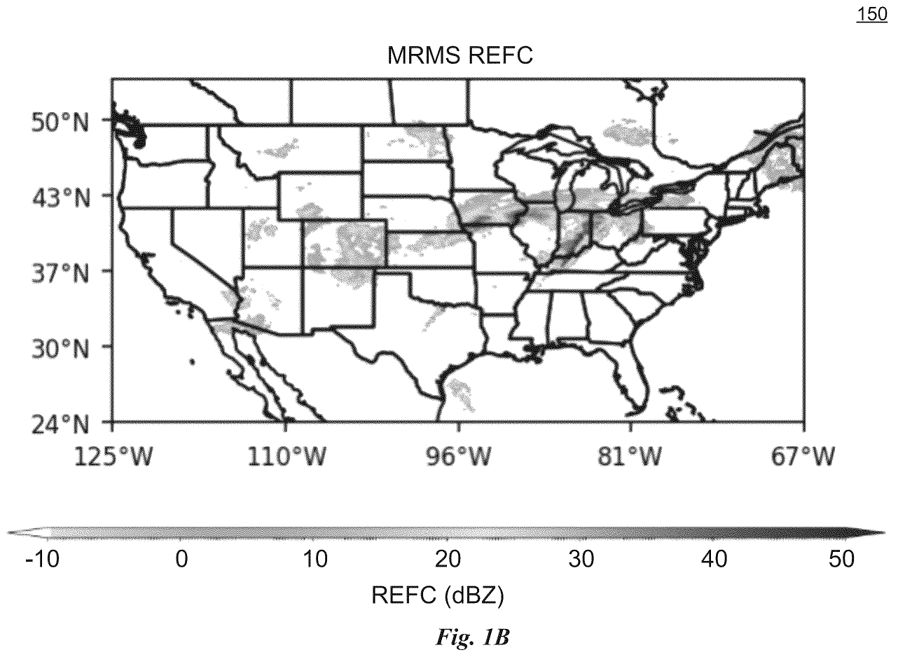

In one or more embodiments, GOES radiance data (or GOES data) include multiple channels (e.g., first channels) corresponding to various measurement conditions. For example, FIG. 1A shows example data 100 from GOES-16 Level 1B radiance channels, in accordance with one or more embodiments. As shown in FIG. 1A, each channel corresponds to a different centralized wavelength, associated with a spectrum range covering visible (VIS), infrared (IR), and near-infrared (NIR) portions of the electromagnetic spectrum. In FIG. 1A, “um” is an abbreviation for micrometer, the unit used for measuring wavelength. Certain GOES radiance dataset offers high-resolution data, such as data with 10-minute temporal resolution or 2-km spatial resolution. The GOES radiance data from different channels, corresponding to different measurement wavelengths (or measurement wavelength ranges), may be used to extract various types of information. For example, Channel 8 (denoted as B8) may be used for upper-level tropospheric water vapor, Channel 9 (denoted as B9) for mid-level tropospheric water vapor, Channel 10 (denoted as B10) for lower-level water vapor, Channel 13 (denoted as B13) for “clean” IR long wave, and more. Specifically, Channel 13 is considered “clean” because it is less sensitive than other infrared window channels to water vapor.

FIG. 1B illustrates an example map 150 representing MRMS REFC fields, in accordance with one or more embodiments. The REFC map shows a single composite reflectivity field, which combines the highest reflectivity values from multiple radars at different altitudes into one two-dimensional map. In one or more embodiments, the REFC map 150 serves as a single type of data layer, or one channel, representing the maximum radar reflectivity vertically through the atmosphere. Various types of data, such as precipitation intensity, wind speed, or other atmospheric conditions, can be derived from the REFC fields. In one or more embodiments, the neural network model is trained to predict MRMS REFC fields based on GOES data. The MRMS REFC fields map 150 may be visualized as MRMS REFC images or frames. The training dataset may provide MRMS REFC data, such as MRMS REFC frames at various time points or data that can be used to construct such image frames, which serve as ground truth during training.

In one embodiment, the diffusion model is used to estimate a residual (or correction) to the MRMS REFC fields estimated by the regression model. In this case, the diffusion process starts from a random noise vector with a pre-determined scale or variance. The diffusion model transforms the random noise vector into a sample of the residual. The diffusion model is conditioned on the GOES observation and the regression model output to achieve this transformation.

In another embodiment, the diffusion model is trained to generate samples of MRMS REFC fields with no conditioning. That is, the diffusion model can transform pure Gaussian noise into an arbitrary sample of MRMS REFC fields. Such an unconditional diffusion model is then used in conjunction with the regression model to generate samples of MRMS REFC fields corresponding to a specific GOES observation. In the diffusion process, the regression model generates an estimate of the MRMS REFC fields (e.g., the prediction provided by the regression model). The estimate is perturbed by a certain amount of random noise, but not to the extent that the input is fully transformed into white noise. In a further embodiment, an unconditional diffusion model is used to transform the perturbed estimate of the MRMS REFC fields into an improved sample (or estimate) of the MRMS REFC fields through a reverse diffusion process. In another embodiment, a conditional diffusion model is used to perform the reverse diffusion process conditioned on the GOES observations.

In one or more embodiments, the diffusion model in the neural network model operates in pixel space for both input and output. For example, the diffusion model receives the predicted second observation from the regression model in the form of an image (e.g., an REFC fields map) and refines the input image to generate an enhanced output image (e.g., an enhanced REFC fields map).

The neural network model leverages a combination of a regression model and a diffusion model to generate high-quality secondary observation data from a different, primary type of observational input. This approach opens new possibilities for utilizing observational data streams in both deterministic forecasting and autoregressive rollout scenarios. It effectively addresses challenges in applications where one type of observation (e.g., satellite radiance) is abundant and reliable, while another (e.g., radar reflectivity) is sparse or unavailable. The neural network model supports a wide range of potential applications, including global weather monitoring, data assimilation in numerical weather prediction (NWP), climatological analysis, disaster management, and more. In one or more embodiments, the neural network model can be configured to forecast extreme weather events (e.g. hurricanes, severe convective storms, hail, etc.), thereby enhancing the ability to monitor and predict high-impact weather phenomena. For example, the neural network model leverages the abundant observational data to predict severe storms.

A method is provided for meteorological prediction, which includes: obtaining a first observation corresponding to a geographical region, predicting, using a regression model, a first image representing a second observation corresponding to the geographical region, and predicting, based on the first image and using a diffusion model, a second image representing a refined second observation corresponding to the geographical region.

According to an embodiment of the method, the first observation comprises data from one or more first channels.

According to an embodiment of the method, the first observation comprises GOES data from one or more channels. In at least one embodiment, the second observation comprises composite reflectivity (REFC) fields.

According to an embodiment of the method, the regression model is trained on the GOES data and radar reflectivity data comprising Multi-Radar Multi-Sensor (MRMS) REFC images. In at least one embodiment, the diffusion model is trained on pairs of MRMS REFC images from the radar reflectivity data.

According to an embodiment of the method, the diffusion model is trained on input-output pairs of MRMS REFC images on a set of time steps at once.

According to an embodiment of the method, predicting the second image includes: initializing the diffusion model with random noise, performing denoising for a number of steps to iteratively denoising a respective noisy input at each denoising step, and outputting the second image. In at least one embodiment, at each denoising step, the denoising is conditioned on the first observation and the second observation.

According to an embodiment of the method, predicting the second image includes: initializing the diffusion model with random noise, generating a perturbed first image based on the first image and a predefined noise schedule, performing denoising for a number of steps to iteratively denoising a respective noisy input at each denoising step, and outputting the second image. In at least one embodiment, the diffusion model is an unconditional diffusion model.

According to an embodiment of the method, predicting the second image includes: initializing the diffusion model with random noise, generating a perturbed first image based on the first image and a predefined noise schedule, performing denoising for a number of steps to iteratively denoising a respective noisy input at each denoising step, and outputting the second image. In at least one embodiment, at each denoising step, the denoising is conditioned on the first observation.

According to an embodiment of the method, the regression model is selected from a set of regression models based on a type of the first observation.

According to an embodiment of the method, the regression model and the diffusion model is trained on a subregion of the geographical region.

According to an embodiment of the method, the regression model and the diffusion model is trained on a region different from the geographical region.

A machine-readable medium is provided having stored thereon a set of instructions, which if performed by one or more processors, cause the one or more processors to perform the method for meteorological prediction.

A system is provided for meteorological prediction, which includes a neural network. The neural network includes at least one regression model and a diffusion model. The at least one regression model is configured to: obtain first observation corresponding to a geographical region, and predict a first image representing a second observation corresponding to the geographical region. The diffusion model is configured to: predict, based on the first image, a second image representing a refined second observation corresponding to the geographical region.

According to an embodiment of the system, the first observation comprises data from one or more first channels.

According to an embodiment of the system, the first observation comprises GOES data from one or more channels. In at least one embodiment, the second observation comprises composite reflectivity (REFC) fields.

According to an embodiment of the system, a regression model of the at least one regression model is trained on the GOES data and radar reflectivity data comprising Multi-Radar Multi-Sensor (MRMS) REFC images. In at least one embodiment, the diffusion model is trained on pairs of MRMS REFC images from the radar reflectivity data.

According to an embodiment of the system, the diffusion model is trained on input-output pairs of MRMS REFC images on a set of time steps at once.

According to an embodiment of the system, predicting the second image includes: initializing the diffusion model with random noise, performing denoising for a number of steps to iteratively denoising a respective noisy input at each denoising step, and outputting the second image. In at least one embodiment, at each denoising step, the denoising is conditioned on the first observation and the second observation.

According to an embodiment of the system, predicting the second image includes: initializing the diffusion model with random noise, generating a perturbed first image based on the first image and a predefined noise schedule, performing denoising for a number of steps to iteratively denoising a respective noisy input at each denoising step, and outputting the second image. In at least one embodiment, the diffusion model is an unconditional diffusion model.

According to an embodiment of the system, predicting the second image includes: initializing the diffusion model with random noise, generating a perturbed first image based on the first image and a predefined noise schedule, performing denoising for a number of steps to iteratively denoising a respective noisy input at each denoising step, and outputting the second image. In at least one embodiment, at each denoising step, the denoising is conditioned on the first observation.

According to an embodiment of the system, the at least one regression model comprises a set of regression models. In at least one embodiment, a regression model is selected from the set of regression models based on a type of the first observation.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

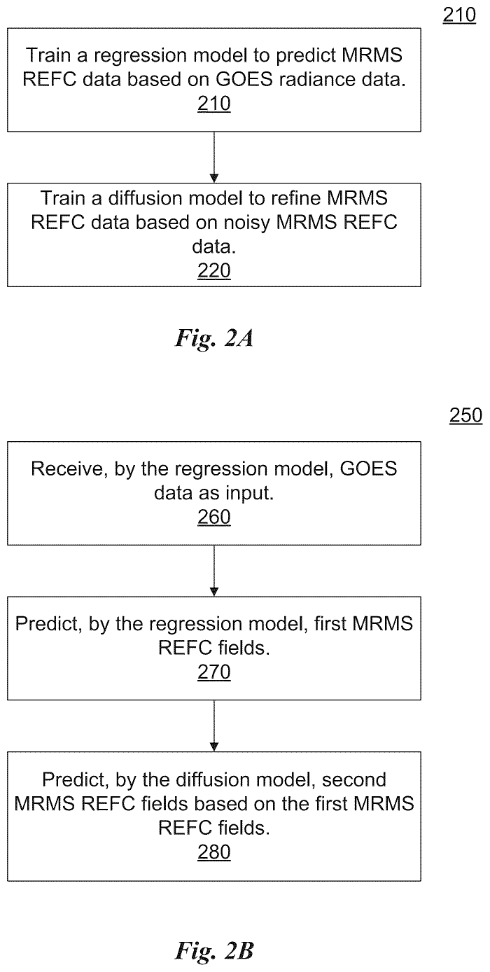

FIG. 2A is a flowchart illustrating a method 200 for training a neural network model, in accordance with one or more embodiments. Each block of method 200, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. Method 200 may be executed by any one system, or any combination of systems, including, but not limited to, those described herein. Furthermore, persons of ordinary skill in the art will understand that any system that performs method 200 is within the scope and spirit of embodiments of the present disclosure.

At stage 210, a regression model is trained to predict MRMS REFC fields based on GOES radiance data of one or more channels. In at least one embodiment, the regression model is trained using both GOES radiance data and MRMS REFC data. The regression model is trained to receive GOES radiance data of one or more channels and to predict MRMS REFC fields. The predicted MRMS REFC fields are compared with the ground truth MRMS REFC fields, and the differences are used to update the regression model.

In one or more embodiments, a suitable loss function, such as mean squared error (MSE) loss function, is utilized to evaluate the difference between the predicted MRMS REFC fields and the ground truth MRMS REFC fields associated with the input GOES radiance data. During training, an iterative optimization process is performed, where a suitable optimization algorithm, such as Adaptive Moment Estimation (or the Adam optimizer), is used to update the model parameters based on the computed gradients of the loss function. Through repeated iterations, the model gradually improves its predictions by minimizing the loss.

In one or more embodiments, the regression model is trained on various channels of GOES radiance data to predict the MRMS REFC data. In one or more embodiments, multiple regression models are trained on different sets of GOES radiance channels as input to predict the MRMS REFC data. As such, during inference, the neural network model may utilize a single regression model or a set of regression models in conjunction with a diffusion model (e.g., obtained by performing stage 220 of method 200) to perform meteorological prediction tasks. For example, when the neural network model includes a set of trained regression models, the neural network model may select a suitable regression model from the regression model set based on the type of input data to predict the MRMS REFC fields.

At stage 220, a diffusion model is trained to refine MRMS REFC fields based on noisy MRMS REFC data. In one or more embodiments, the diffusion model is trained using solely the MRMS REFC data. In one or more embodiments, the diffusion model is trained using both the MRMS REFC data and the GOES radiance data. The diffusion model receives one or more noisy MRMS REFC image frames as input to predict one or more refined MRMS REFC image frames as output. In one or more embodiments, a suitable loss function, such as Elucidated Diffusion Models (EDM) loss function, is utilized to evaluate the difference between the predicted MRMS REFC fields and the ground truth MRMS REFC fields associated with the noisy input. During training, an iterative optimization process is performed, where a suitable optimization algorithm, such as Adaptive Moment Estimation (or the Adam optimizer), is used to update the model parameters based on the computed gradients of the loss function. Through repeated iterations, the model gradually improves its predictions by minimizing the loss.

In one or more embodiment, the diffusion model receives GOES radiance data to condition the diffusion process. In at least one embodiment, the diffusion model is a video diffusion model. The video diffusion model may be trained on one or more input-output pairs (e.g., MRMS REFC image pairs) that correspond to a specific time window. For example, the video diffusion model is trained on input-output MRMS REFC image pairs from a set of six time steps at once, leveraging its video diffusion capability. When each time step is spaced 15 minutes apart, six time steps would correspond to a total processing time window of one and a half hours. This approach allows the diffusion model to learn temporal coherence of the MRMS REFC data and exploit its temporal correlation with the temporal dynamics of the GOES radiance data as part of the learning. It should be noted that the number of input-output pairs, the number of time steps, the size of the time window, and other parameters are not limited to this example.

The neural network model may adopt various architectures including a regression model and a diffusion model. The diffusion model may take various types, such as conditional, unconditional, residual, or others. Regardless of the architecture adopted, the neural network model can be trained using the method 200 through stages 210 and 220. The diffusion model may be referred to as a diffusion denoiser. In at least one embodiment, the diffusion model includes a denoising network.

In at least one embodiment, the neural network model includes a regression model and a conditional residual diffusion model. In the present disclosure, the term “residual” refers to the difference between the true MRMS target (e.g., ground truth MRMS REFC fields or images) and the output of the regression model (e.g., the predicted MRMS REFC fields or images). At stage 220, the conditional residual diffusion model can be trained through the following processes: (i) ground truth MRMS REFC data (or a latent representing the ground truth) is corrupted with random Gaussian noise; (ii) the denoising network performs a denoising process for a number of steps to iteratively denoising the noisy input; and (iii) at the end of the diffusion process, the denoising network outputs a sample that estimates the residual over the prediction from the regression model. In at least one embodiment, at each denoising step, the input to the denoising network is a noisy latent (or a less noisy version from output from the previous denoising step), the GOES input, and the regression output (e.g., the prediction from the regression model). In at least one embodiment, at each denoising step, the denoising network performs a reverse diffusion process, for example by solving an Ordinary Differential Equation (ODE) or Stochastic Differential Equation (SDE) with a drift term provided by the denoising network, to remove a certain amount of noise from the input. The drift term, predicted by the denoising network, represents the direction of denoising at each step in the reverse diffusion process.

In at least one embodiment, after training with the above-described denoising objective, the denoising network can be used to generate samples of the residual, starting from pure random noise, as part of a reverse diffusion process. As such, the conditional residual diffusion model is trained to generate a residual estimate from various input including the GOES observation and the output of the regression model. For example, the denoising network learns to denoise the input noisy residual and obtain a clean residual. This estimated residual from the diffusion model (e.g., the conditional residual diffusion model) is added to the regression output to produce the estimated target MRMS reflectivity (e.g., the estimated target MRMS REFC fields).

In at least one embodiment, the neural network model includes a regression model and an unconditional diffusion model. In at least one embodiment, the unconditional diffusion model is trained to denoise samples from the MRMS distribution. For example, the training sets up the unconditional diffusion model to generate unconditional samples from the MRMS distribution. At stage 220, the unconditional diffusion model can be trained through the following processes: (i) ground truth MRMS REFC data (or a latent representing the ground truth) is corrupted with a predefined noise schedule; (ii) the denoising network performs a denoising process for a number of steps to iteratively denoising the noisy input; and (iii) at the end of the diffusion process, the denoising network outputs a sample as an estimate of the clean MRMS REFC data. In at least one embodiment, the predefined noise schedule is determined based on a random noise and a predefined magnitude or noise scale. The predefined magnitude or noise scale is used as a hyperparameter of the inference process.

In at least one embodiment, the neural network model includes a regression model and a conditional diffusion model. In at least one embodiment, the conditional diffusion model is trained to generate MRMS samples conditioned on the GOES observation (rather than a pure unconditional generation task). For example, the conditional diffusion model is trained to generate denoised MRMS samples from noised MRMS samples conditioned on GOES observations. At stage 220, the conditional diffusion model can be trained through the following processes: (i) ground truth MRMS REFC data (or a latent representing the ground truth) is corrupted with a predefined noise schedule; (ii) the denoising network performs a denoising process for a number of steps to iteratively denoising the noisy input; and (iii) at the end of the diffusion process, the denoising network outputs a sample as an estimate of the clean MRMS REFC data. In at least one embodiment, the predefined noise schedule is determined based on a random noise and a predefined magnitude or noise scale. The predefined magnitude or noise scale is used as a hyperparameter of the inference process.

In at least one embodiment, the noise schedule is incorporated using a positional embedding for noise levels, allowing the diffusion model to understand and process different stages of the diffusion process. In at least one embodiment, a series of linear layers in the diffusion model (e.g., the denoising network) process the noise embeddings, providing context for the generative process. In at least one embodiment, the diffusion model has an encoder-decoder structure with a plurality of blocks. Each block in the diffusion model takes the embedded noise information as additional input, allowing for noise-level-dependent processing. In at least one embodiment, self-attention layers are included at specified resolutions, for capturing long-range dependencies in weather patterns. In at least one embodiment, during inference, the noise schedule is used to scale the REFC output predicted from the regression model based on the current noise level and the expected data statistics. The expected data statistics may be represented by the standard deviation or dynamic range of the REFC data, which can be estimated from the training dataset. In at least one embodiment, an Elucidated Diffusion Model (EDM) preconditioner is used to convert a noise level (e.g., the current noise level at a given denoising iteration) into a spatial embedding that is input to the corresponding network layer or block. This approach enables the neural network model to handle varying noise scales, supporting the iterative denoising process in the diffusion model.

In one or more embodiments, the diffusion model is trained on input-output pairs across a set of time steps simultaneously, leveraging the video diffusion capability of the diffusion model. This enables the diffusion model to learn spatio-temporal coherence in diffusion-based predictions.

FIG. 2B is a flowchart illustrating a method 250 for meteorological prediction, in accordance with one or more embodiments. Each block of method 250, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. Method 250 may be executed by any one system, or any combination of systems, including, but not limited to, those described herein. Furthermore, persons of ordinary skill in the art will understand that any system that performs method 250 is within the scope and spirit of embodiments of the present disclosure. The method 250 can be performed by a neural network model trained through method 200. The neural network model includes at least one regression model and a diffusion model. In one or more embodiments, the neural network model obtains first observation data that includes GOES data from one or more channels and predict second observation data represented by MRMS REFC fields. The MRMS REFC fields may be represented in various forms during the process, including latent representations (e.g., encoded by an encoder) or image formats.

At stage 260, the regression model receives the GOES data as input. In one or more embodiments, the neural network model includes a set of regression models. Based on the channels present in the GOES data, the neural network model may select a suitable regression model from the set to receive the respective GOES data and perform the prediction at stage 270.

At stage 270, the regression model predicts first MRMS REFC fields.

At stage 280, the diffusion model predicts second MRMS REFC fields based on the first MRMS REFC fields.

As discussed in the training method 200, the diffusion model may adopt various architectures. Depending on the type of diffusion model used in the neural network model, the prediction by the diffusion model may be performed using different methods.

In one embodiment, a conditional residual diffusion model is used. The conditional residual diffusion model includes a diffusion network and a denoising network. The diffusion process is initialized with Gaussian random noise. For example, the initial input to the diffusion model is a noisy latent representing the Gaussian random noise. Then, for a certain number of steps, the diffusion network performs a reverse diffusion process by solving an ODE or SDE with the drift term provided by the denoising network. At each step, the input to the denoising network is the noisy latent, the GOES input, and the regression output (e.g., the first MRMS REFC fields predicted by the regression model at stage 270). At the end of the diffusion process, the diffusion model obtains a sample that estimates the residual over the regression output. This residual estimate is added to the regression output to get the estimated target MRMS reflectivity (e.g., the second MRMS REFC fields).

In another embodiment, an unconditional diffusion model is used. The output of the regression model (e.g., the first MRMS REFC fields from stage 270) is perturbed by a predefined noise schedule. For example, the noise schedule corresponds to an amount of noise determined by a hyperparameter. The diffusion model performs a reverse diffusion process, which is initiated from the noise level (or “time”) corresponding to the amount of noise added to the regression output. The diffusion model then carries out the reverse diffusion process over a series of steps, based on the starting noise level and the total number of desired steps along the reverse diffusion trajectory. In at least one embodiment, the perturbed first MRMS REFC fields is represented by a noisy latent.

In yet another embodiment, a conditional diffusion model is used. Similar to the unconditional diffusion model case, the output of the regression model (e.g., the first MRMS REFC fields from stage 270) is perturbed by a predefined noise schedule. Similarly, the diffusion model performs a reverse diffusion process, which is initiated from the noise level (or “time”) corresponding to the amount of noise added to the regression output. The perturbed first MRMS REFC fields may be represented by a noisy latent. The diffusion model then carries out the reverse diffusion process over a series of steps, based on the starting noise level and the total number of desired steps along the reverse diffusion trajectory. Additionally, the diffusion model receives the GOES input as a conditioning signal for the diffusion process.

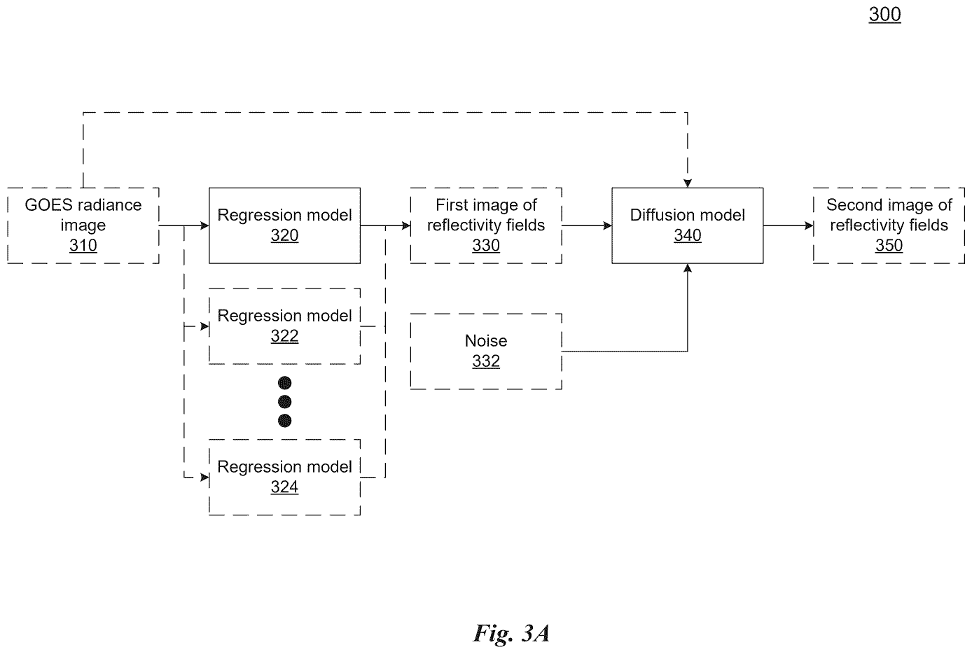

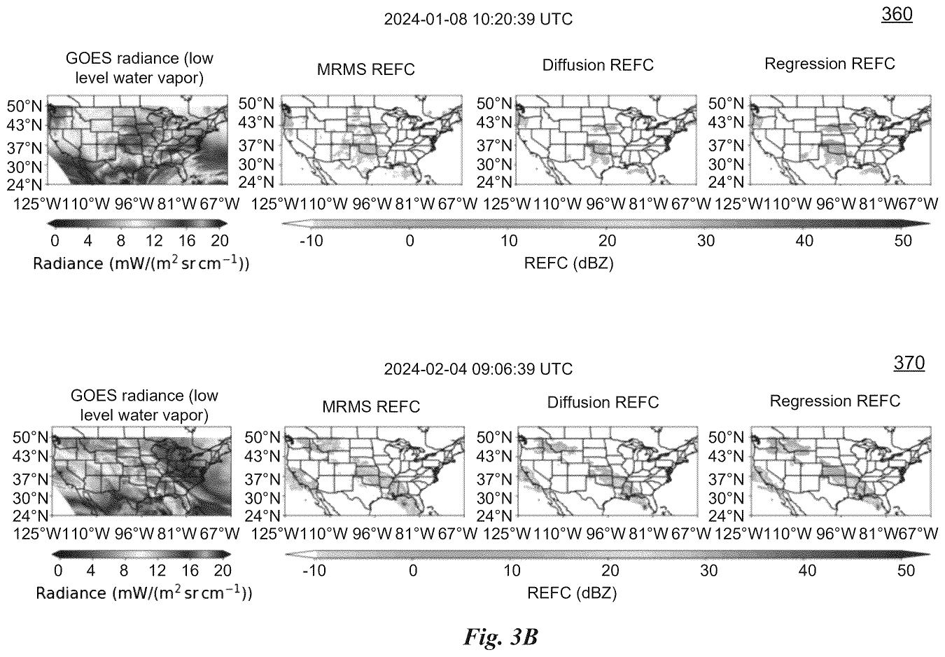

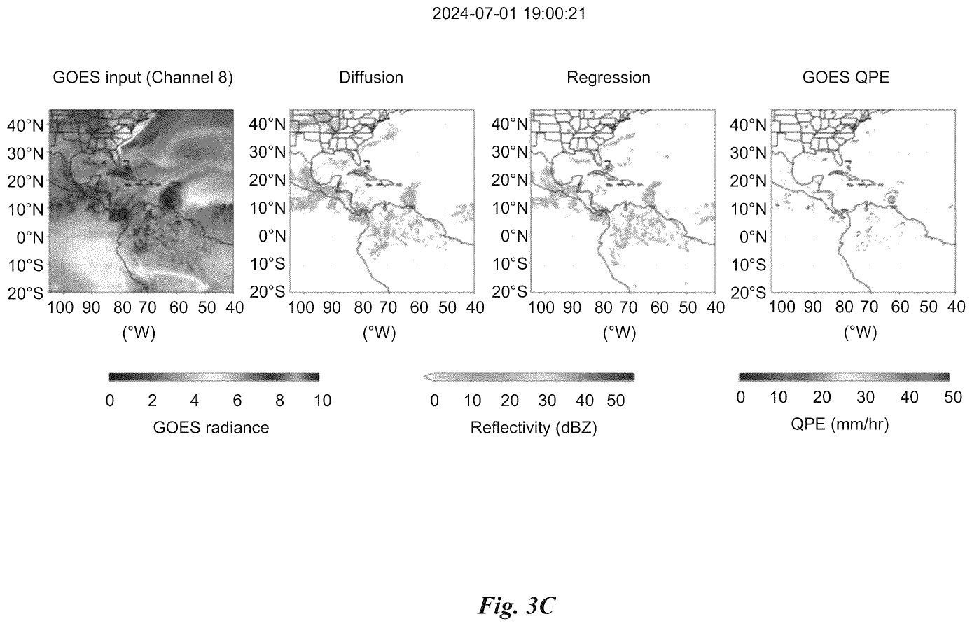

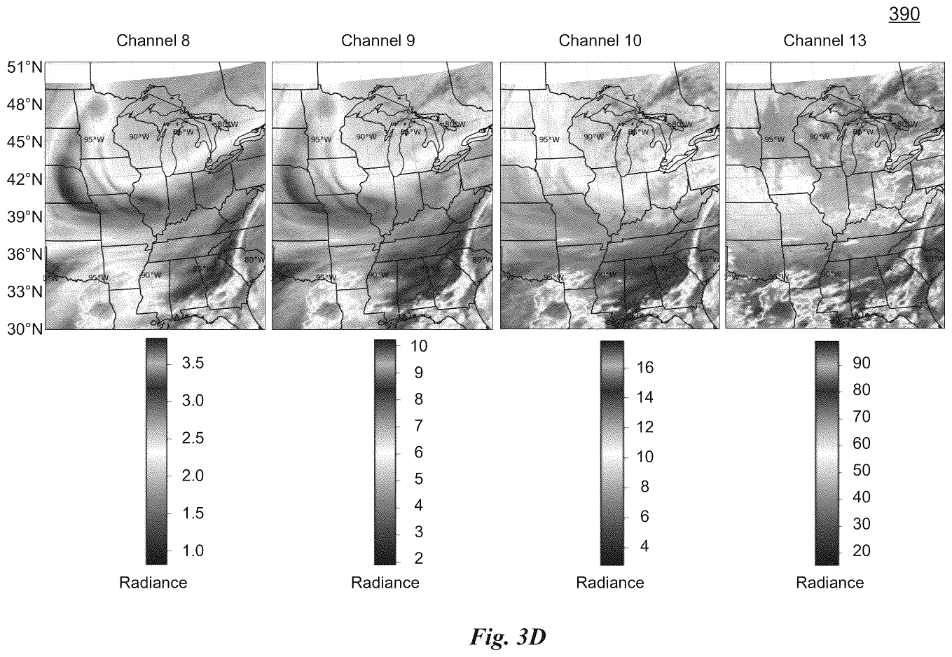

FIG. 3A is a flow diagram illustrating a method 300 for meteorological prediction, in accordance with one or more embodiments. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. Method 300 may be executed by any one system, or any combination of systems, including, but not limited to, those described herein. Furthermore, persons of ordinary skill in the art will understand that any system that performs method 300 is within the scope and spirit of embodiments of the present disclosure.

In the illustrated example, the input includes a GOES radiance image at block 310. In one or more embodiments, the GOES radiance image may represent GOES radiance data from one or more channels, such as from the channels as shown in FIG. 1A.

In one or more embodiments, a regression model 320 is used to predict a first image of reflectivity fields at block 330. For example, the first image of reflectivity fields may be an MRMS REFC image similar to the image shown in FIG. 1B.

In one or more embodiments, one regression model from a set of regression models, including regression models 320, 322, . . . , 324, may be used for predicting the first image of reflectivity fields at block 330.

The diffusion model at block 340 is used to predict a second image of reflectivity fields at block 350 based on the first image of reflectivity fields at block 330.

As discussed above, the diffusion model may be of various types. In one embodiment, the diffusion model is a conditional residual diffusion model, which receives noise 332, the first image of reflectivity fields at block 330, and the GOES radiance image 310 as input to predict the second image of reflectivity fields at block 350. In another embodiment, the diffusion model is an unconditional diffusion model, which receives noise 332, the first image of reflectivity fields at block 330 perturbed by the noise 332 as input to predict the second image of reflectivity fields at block 350. In yet another embodiment, the diffusion model is a conditional diffusion model, which receives the first image of reflectivity fields at block 330 perturbed by the noise 332 and the GOES radiance image 310 as input to predict the second image of reflectivity fields at block 350.

In at least one embodiment, the data used to train the neural network model is limited to a subregion of a visualized horizontal domain, such as the longitude range of 100° W to 80° W and the latitude range of 30° N to 50° N. During inference, the neural network model is used to predict results outside this subregion, demonstrating the model's ability to generalize spatially. As such, the neural network model is capable of learning the relationships between GOES and REFC within a region where data was available, and then synthesizing REFC in surrounding regions using only GOES radiances. This demonstrates the neural network model's utility in gap-filling inherently sparse Earth system observations like REFC, by leveraging more uniformly distributed observational modalities such as GOES.

FIG. 3B illustrates results from meteorological prediction, in accordance with one or more embodiments. As shown in FIG. 3B, row 360 demonstrates prediction results for a winter convection event moving across multiple states, starting from Jan. 8, 2024, at 11:15 UTC. Row 370 demonstrates prediction results for an event starting on Feb. 4, 2024, at 09:06:39 UTC. The image labeled “GOES radiance (lower level water vapor)” represents one GOES radiance channel corresponding to lower level water vapor. The image labeled “MRMS REFC” represents ground truth MRMS REFC fields. The image labeled “diffusion REFC” represents MRMS REFC fields output from the diffusion model of the neural network model. The image labeled “Regression REFC” represents MRMS REFC fields output from a regression model (e.g., the regression model of the neural network model or another regression model built upon it). A neural network model, including a regression model and a diffusion model, is obtained using method 200. The diffusion model of the neural network model may be of various types, including conditional and unconditional models.

The results as shown in FIG. 3B demonstrate the models'capabilities under different meteorological conditions across the contiguous United States (CONUS) and highlight key strengths of the neural network model.

Row 360 presents the results for an event starting on Jan. 8, 2024, at 10:20:39 UTC. In this case, both the diffusion and regression models successfully captured the general spatial patterns of REFC as observed in the MRMS data. This is evident in the similar REFC distribution across the central and eastern US. The diffusion model demonstrated a better ability to estimate the intensity of reflectivity, particularly for moderate reflectivity values (10-30 dBZ). This is noticeable in the more accurate representation of the REFC patterns over Texas and the Midwest. The regression model tends to produce smoother, more generalized REFC, while the diffusion model captured more of the fine-scale structure present in the MRMS REFC. This is particularly evident in the more detailed patterns over the southeastern states. Both models show some instances of false positives, predicting REFC in areas where the MRMS data didn't have any REFC. However, the diffusion model appeared to have fewer such instances, particularly in the western states. The regression model is more sensitive to low REFC values, as seen in the more extensive areas of low REFC (0-10 dBZ) predicted across the northern states.

Row 370 presents results for an event starting on Feb. 4, 2024, at 09:06:39 UTC. This case study features areas of high REFC (>40 dBZ), particularly over Texas and the Gulf coast. Both models detected these high-intensity events, but the diffusion model more accurately represented the extent and intensity of the system, while the regression model tended to underestimate its coverage. The diffusion model demonstrates relatively superior spatial coherence in its predictions, producing more realistic and contiguous REFC, particularly over Texas and the Southeast. A secondary weather system is visible along the west coast in the MRMS REFC. The diffusion model detected this system and represented its spatial extent more accurately.

Results from rows 360, 370, and other results exhibit several consistent patterns. The diffusion and regression models demonstrated complementary strengths: the diffusion model generally excelled at capturing spatial patterns and intensity ranges, while the regression model sometimes performed better at detecting widespread areas of low reflectivity. Additionally, the reconstructed REFC fields showed a clear relationship to the input GOES radiance data, highlighting the models'ability to effectively leverage satellite information. Furthermore, both models showed increased uncertainty in predicting very high reflectivity values (>40 dBZ), though the diffusion model generally performed better in these cases. The use of multiple time steps in training (particularly for the diffusion model) also appeared to contribute to temporally consistent predictions across sequential time periods.

FIG. 3C illustrates results from meteorological prediction, in accordance with one or more embodiments. As shown in FIG. 3C, row 380 demonstrates prediction results for hurricane Beryl period from Jul. 1, 2024. The image labeled “GOES input (Channel 8)” represents channel 8 of GOES radiance data (e.g., corresponding to B8 as shown in FIG. 1A). The image labeled “diffusion” represents MRMS REFC fields output from the diffusion model of the neural network model. The image labeled “Regression” represents MRMS REFC fields output from a regression model (e.g., the regression model of the neural network model or another regression model built upon it). The image labeled “GOES QPE” represents GOES-derived quantitative precipitation estimate (QPE). A neural network model, including a regression model and a diffusion model, is obtained using method 200. The diffusion model of the neural network model may be of various types, including conditional and unconditional models.

In this example, the neural network model is used to predict REFC fields based on GOES full disk data for hurricane Beryl period from Jul. 1, 2024. FIG. 3D shows example training dataset 390 used for both regression and diffusion models, in accordance with one or more embodiments. As shown in FIG. 3D, the training dataset 390 includes GOES Channel 8, 9, 10, and 13 data that only cover the eastern United States.

There is little surface-based radar coverage over open oceans, which is one of the motivations for providing radar products in such regions. GOES-derived quantitative precipitation estimates (QPE) are used to show the extent of surface precipitation and to compare the reflectivity predictions produced by the neural network model.

FIG. 3C provides valuable insights into the performance of both the diffusion and regression models in a predominantly oceanic environment, as well as their ability to capture the tropical weather patterns, which are completely unseen during training. The GOES input channel shows complex cloud patterns across the tropical Atlantic, Caribbean, and parts of South America, indicating the presence of tropical weather patterns in these areas. Both the diffusion and regression models successfully detected and reconstructed REFC associated with these systems, demonstrating their ability to interpret satellite data in unseen tropical oceanic environments.

The diffusion model shows a more detailed and spatially coherent distribution of REFC, particularly in the Caribbean sea and off the northern coast of South America. The diffusion model captures a wider range of REFC, including areas of higher intensity (20-40 dBZ). The regression model produces a more conservative estimate, with a tendency towards lower REFC and less spatial variation. The regression model captures the general locations of weather systems (including hurricane Beryl) but with relatively less intensity and detail. The diffusion model demonstrates slightly better ability in reproducing fine-scale structures (similar to CONUS cases above), especially visible in scattered convective cells across the Atlantic and in the Caribbean. The diffusion model suggests a slightly larger coverage area for most systems, which aligns well with the patterns in the GOES data. The GOES QPE here provides an additional reference for evaluating model performance in absence of radar in these areas. Both models show general agreement with the QPE in identifying areas of precipitation, particularly in the Caribbean and off the South American coast and related to hurricane Beryl. The diffusion model's predictions of high REFC areas correlate well with regions of higher QPE values, suggesting good skill in identifying potentially intense precipitation.

This case study highlights the models'potential in reconstructing REFC over oceanic regions where traditional radar coverage is limited or non-existent. Both models demonstrate the ability to infer meaningful REFC patterns solely from satellite data, which is particularly valuable for such observation-sparse regions. While both models capture the general patterns, there is some uncertainty in the exact intensity and location of the most intense convection related to hurricane Beryl. These results suggest that these diffusion and regression model approaches, have significant potential for enhancing our understanding and monitoring of weather systems in regions with limited radar coverage and thus can act as a tool to potentially in-fill REFC in such regions.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

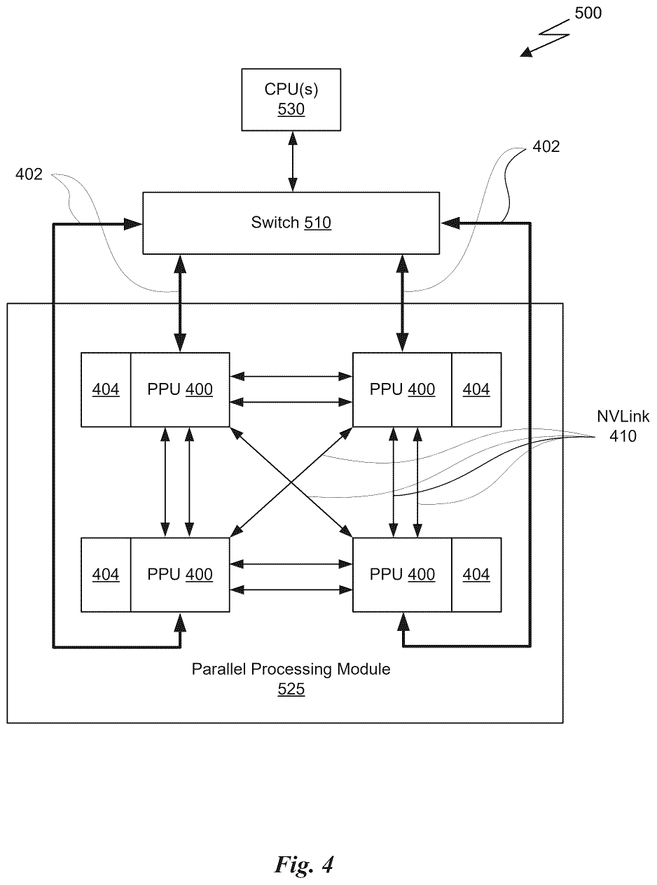

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

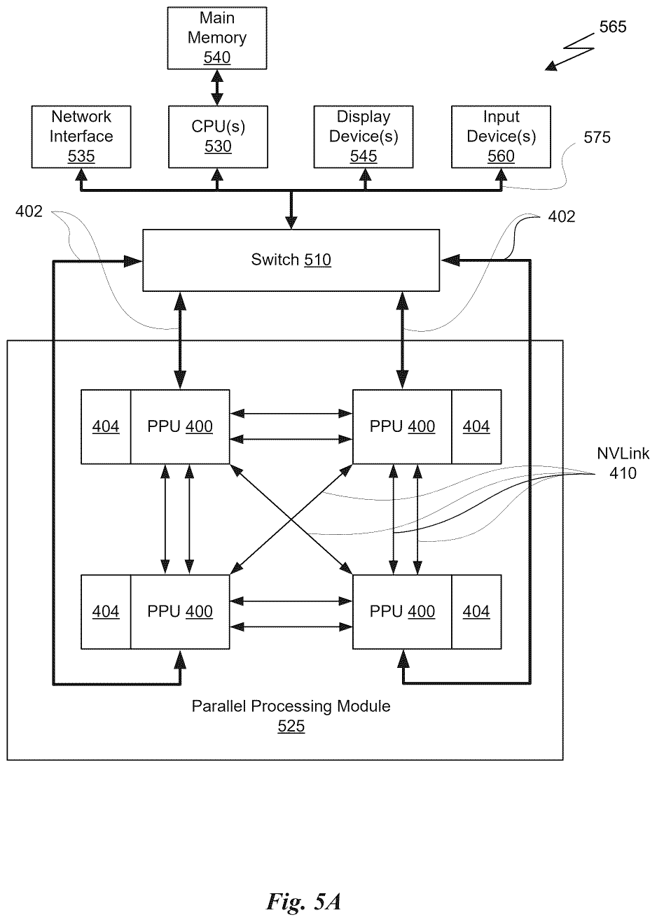

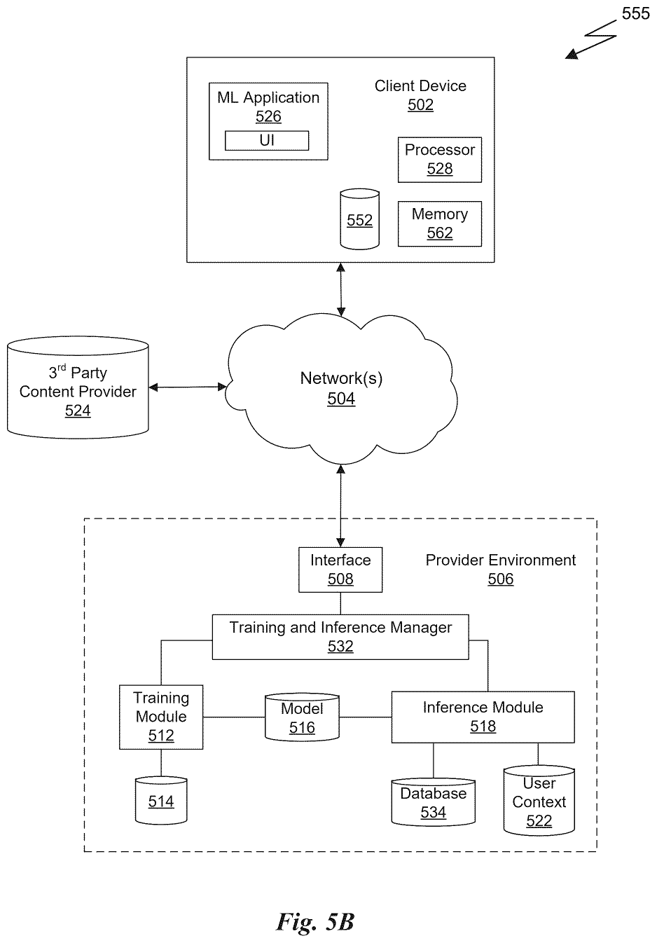

FIG. 5A illustrates an exemplary system 565 in which the various architecture and/or functionality of the various previous embodiments may be implemented. The exemplary system 565 may be configured to implement the method 200 shown in FIG. 2A and/or the method 250 shown in FIG. 2B.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments - in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

### Example Streaming System

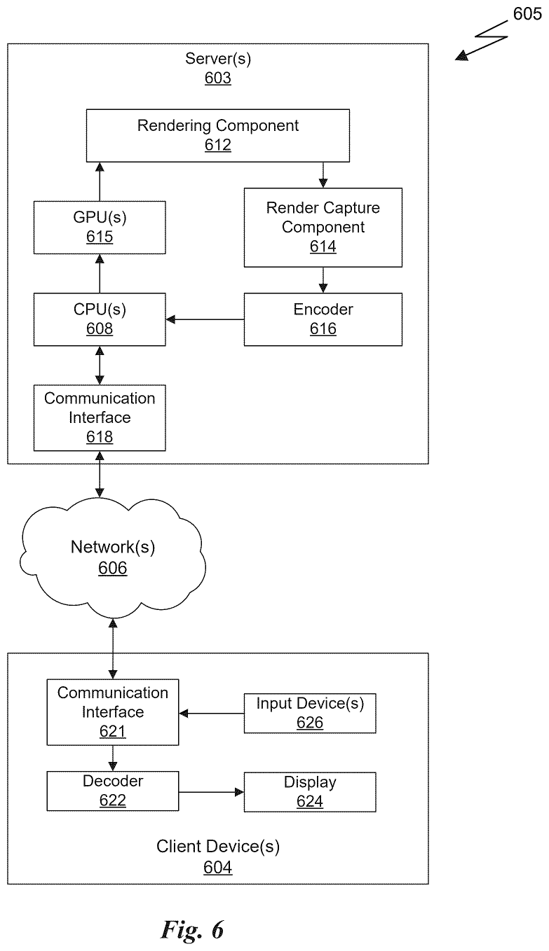

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for meteorological prediction, comprising:
obtaining a first observation corresponding to a geographical region;
predicting, using a regression model, a first image representing a second observation corresponding to the geographical region; and
predicting, based on the first image and using a diffusion model, a second image representing a refined second observation corresponding to the geographical region.

2. The method of claim 1, wherein the first observation comprises data from one or more first channels.

3. The method of claim 1, wherein the first observation comprises GOES data from one or more channels, and wherein the second observation comprises composite reflectivity (REFC) fields.

4. The method of claim 3, wherein the regression model is trained on the GOES data and radar reflectivity data comprising Multi-Radar Multi-Sensor (MRMS) REFC images, and wherein the diffusion model is trained on pairs of MRMS REFC images from the radar reflectivity data.

5. The method of claim 4, wherein the diffusion model is trained on input-output pairs of MRMS REFC images on a set of time steps at once.

6. The method of claim 1, wherein predicting the second image comprises:
initializing the diffusion model with random noise;
performing denoising for a number of steps to iteratively denoising a respective noisy input at each denoising step, wherein at each denoising step, the denoising is conditioned on the first observation and the second observation; and
outputting the second image.

7. The method of claim 1, wherein predicting the second image comprises:
initializing the diffusion model with random noise;
generating a perturbed first image based on the first image and a predefined noise schedule;
performing denoising for a number of steps to iteratively denoising a respective noisy input at each denoising step, wherein the diffusion model is an unconditional diffusion model; and
outputting the second image.

8. The method of claim 1, wherein predicting the second image comprises:
initializing the diffusion model with random noise;
generating a perturbed first image based on the first image and a predefined noise schedule;
performing denoising for a number of steps to iteratively denoising a respective noisy input at each denoising step, wherein at each denoising step, the denoising is conditioned on the first observation; and
outputting the second image.

9. The method of claim 1, wherein the regression model is selected from a set of regression models based on a type of the first observation.

10. The method of claim 1, wherein the regression model and the diffusion model is trained on a subregion of the geographical region, or
wherein the regression model and the diffusion model is trained on a region different from the geographical region.

11. A system for meteorological prediction, comprising:
a neural network comprising:
at least one regression model configured to:
obtain first observation corresponding to a geographical region; and
predict a first image representing a second observation corresponding to the geographical region; and
a diffusion model configured to:
predict, based on the first image, a second image representing a refined second observation corresponding to the geographical region.

12. The system of claim 11, wherein the first observation comprises data from one or more first channels.

13. The system of claim 11, wherein the first observation comprises GOES data from one or more channels, and wherein the second observation comprises composite reflectivity (REFC) fields.

14. The system of claim 13, wherein a regression model of the at least one regression model is trained on the GOES data and radar reflectivity data comprising Multi-Radar Multi-Sensor (MRMS) REFC images, and wherein the diffusion model is trained on pairs of MRMS REFC images from the radar reflectivity data.

15. The system of claim 14, wherein the diffusion model is trained on input-output pairs of MRMS REFC images on a set of time steps at once.

16. The system of claim 11, wherein predicting the second image comprises:
initializing the diffusion model with random noise;
performing denoising for a number of steps to iteratively denoising a respective noisy input at each denoising step, wherein at each denoising step, the denoising is conditioned on the first observation and the second observation; and
outputting the second image.

17. The system of claim 11, wherein predicting the second image comprises:
initializing the diffusion model with random noise;
generating a perturbed first image based on the first image and a predefined noise schedule;
performing denoising for a number of steps to iteratively denoising a respective noisy input at each denoising step, wherein the diffusion model is an unconditional diffusion model; and
outputting the second image.

18. The system of claim 11, wherein predicting the second image comprises:
initializing the diffusion model with random noise;
generating a perturbed first image based on the first image and a predefined noise schedule;
performing denoising for a number of steps to iteratively denoising a respective noisy input at each denoising step, wherein at each denoising step, the denoising is conditioned on the first observation; and
outputting the second image.

19. The system of claim 11, wherein the at least one regression model comprises a set of regression models, and wherein a regression model is selected from the set of regression models based on a type of the first observation.

20. A non-transitory computer-readable media storing computer instructions for meteorological prediction that, when executed by one or more processors, cause the one or more processors to perform the steps of:
obtaining a first observation corresponding to a geographical region;
predicting, using a regression model, a first image representing a second observation corresponding to the geographical region; and
predicting, based on the first image and using a diffusion model, a second image representing a refined second observation corresponding to the geographical region.
